(19) United States
(12) Patent Application Publication
(10) Pub. No.: US 2023/0312865 A1
(43) Pub. Date: Oct. 5, 2023

(54) ELECTRICALLY CONDUCTIVE COMPOSITIONS

(71) Applicants: SPECIALTY ELECTRONIC MATERIALS BELGIUM, SRL, Braine-l' Alleud (BE); DSP S.A.S., PARIS (FR)

(72) Inventors: JUSTINE LHOEST, SENEFFE (BE); ALEXIS BOBENRIETH, MONS (BE); LAURIE MAES, SENEFFE (BE); XAVIER THOMAS, PARIS (FR)

(21) Appl. No.: 18/042,129

(22) PCT Filed: Aug. 11, 2021
(86) PCT No.: PCT/US21/45476

§ 371 Date: Feb. 17, 2023

Related U.S. Application Data
(60) Provisional application No. 63/071,399, filed on Aug. 28, 2020.

(51) Int. Cl. C08K 3/04; C08L 83/04; C08K 3/36; H01B 1/24

(52) U.S. Cl. CPC C08K 3/041; C08L 83/04; C08K 3/36; H01B 1/24; C08L 2203/20

(57) ABSTRACT

An electrically conductive composition comprising a homogeneous dispersion of up to 5% (w/w) single wall carbon nanotubes, in a dielectric polymeric matrix material. A method of making a conductive composition, comprising the step of: combining 0.1-5% single wall carbon nanotubes with a dielectric matrix material to form a homogeneous dispersion of the single wall carbon nanotubes in the dielectric matrix material and to reduce the size of the agglomerates of the single wall carbon nanotubes.

### CROSS-REFERENCE TO RELATED APPLICATIONS

None

### FIELD OF THE INVENTION

The present invention relates, generally, to electrically conductive composition for electrodes comprising carbon nanotubes in a matrix material.

### BACKGROUND OF THE INVENTION

Electrodes are used in the medical field in wearable devices for performing tests and electrotherapy such as electroencephalograms (EEG) and electrocardiograms (ECG) and neuromuscular electrical stimulation (NMES). For optimal performance, the electrodes should have close contact with the skin and that contact should be maintained for the duration of the test of therapy. The duration of the test can be from a few minutes to days or even longer. In addition, the impedance of the electrode should be in the range of the cutaneous substrate.

Different technologies have been employed to make the electrodes. For example, hydrogel technology and filled polymers forming polymer matrices have been used. However, electrodes employing these technologies have drawbacks. Electrodes made using hydrogel technology can lose water over time, and, consequently, lose adhesive and impedance properties. In polymer matrices, large amounts of electrically conductive fillers typically must be added to provide the necessary and preferred impedance, but the high levels of filler interfere with adhesive and elastic properties of the electrode.

### BRIEF SUMMARY OF THE INVENTION

The present invention is directed to an electrically conductive composition comprising a homogeneous dispersion of up to 5% (w/w) single wall carbon nanotubes, in a dielectric polymeric matrix material.

The present invention is further directed to a method of making a conductive composition, comprising the step of: combining 0.1-5% single wall carbon nanotubes with a dielectric matrix material to form a homogeneous dispersion of the single wall carbon nanotubes in the dielectric matrix material and to reduce the size of the agglomerates of the single wall carbon nanotubes.

The electrically conductive composition of the invention can be used to form wearable electronics and electrodes which have improved impedance and adhesive properties, wherein the electrodes maintain impedance and adhesive properties better that prior art matrix-type electrodes.

### BRIEF DESCRIPTION OF THE DRAWINGS

FIG. 1 represents images taken of films cast of formulation comprising liquid silicone rubber and 1.5% (w/w) single wall carbon nanotubes using a transmission electron microscope at a scale of 1 micrometer and 200 nanometers.

FIG. 2 represents an image of a film cast of a formulation comprising a silicone based skin adhesive comprising 1.5% (w/w) single wall carbon nanotubes using a transmission election microscope at a scale of 1 micrometer.

FIG. 3 represents an image of a film cast of a formulation comprising a silicone based skin adhesive comprising 1.5% (w/w) single wall carbon nanotubes using a transmission election microscope at a scale of 200 nanometers.

FIG. 4 represents a simulated ECG signal of an electrode made with the electrically conductive composition.

FIG. 5 represents a measured ECG signal of an electrode made with the electrically conductive composition.

FIG. 6 is a graph of the measured conductivity of an electrically conductive composition Example with single wall carbon nanotubes and two Comparative Examples comprising multiwall carbon nanotubes.

FIG. 7 is a graph of the measured conductivity of a film made of an electrically conductive composition with various amounts of single wall carbon nanotubes.

FIG. 8 represents the results of measured resistivity of electrodes coated with films made with the electrically conductive composition comprising a liquid silicone rubber at various film thicknesses and coated on PET PE876.

FIG. 9 represents the results of measured resistivity of electrode coated with films made with the electrically conductive composition comprising a silicone adhesive at various film thicknesses on PET PE874.

FIG. 10 represents measurement of resistivity of electrically conductive compositions where lack of interference between electrodes is demonstrated.

FIG. 11 represents the scheme for testing potential interference created by the electrically conductive composition where the film from the electrically conductive composition is doubled (Formulation 3F), where the top (superior) Intexar material was removed and then re-adhered to film from the electrically conductive formulation, and then compared to a normal arrangement (3E)

FIG. 12 represents the measured resistivity of coatings of electrically conductive compositions in electrodes made by transfer coating.

### DETAILED DESCRIPTION OF THE INVENTION

The terms “comprises,” “comprising,” “includes,” “including,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.
PET is acronym for polyethylene terephthalate).

TPU is an acronym for thermoplastic polyurethane).

An electrically conductive composition, comprising: a homogeneous dispersion of
(a) up to 5% (w/w) single wall carbon nanotubes, in
(b) a dielectric polymeric matrix material.

Multi-Walled Carbon Nanotube (MWCNT) consist of multiple rolled layers of graphene rolled around each other (the smaller diameter in the center and then the diameter becomes bigger and bigger). The tubes are so imbricated in each other. The diameter of MWCNT are typically in the range of 5 nanometers (nm) to 100 nm. The interlayer distance in MWCNT is close to the distance between graphene layers in graphite.

The single-wall carbon nanotube (SWCNT) is a one-layer thick MWCNT. The SWCNTs have a diameter and a tube length, where the diameter is distance is compared to the diameter of a cylinder and the tube length the length of a cylinder. The SWCNT is a rolled layer of graphene with a diameter close to 1.3 nm, alternatively from 0.5 nm to 3 nm, alternatively from 1 nm to 1.5 nm, and a tube length that can be up to 15 μm (micrometers), alternatively up to 10 μm, alternatively from 5 to 10 μm. SWCNT are very often capped at the end and have only one cylindrical carbon wall. In one embodiment, the SWCNT have a maximum particle size diameter, alternatively a particle size diameter up to 5 nm, alternatively up to 3 nm, alternatively up to 1.5 nm. One skilled in the art would know how to measure particle size diameter and tube length. For example, particle size diameter and tube length may be measured using commercial particle size analyzers, alternatively particle size and tube length may be measure using microscopic techniques known the art.

The SWCNT useful in the invention is available commercially. For example, SWCNT may be purchased from the OCSiAl company based in Luxembourg. The SWCNT may be produced in a specific reactor called “Graphetron” using free metal catalyst nanoparticles. This process is based on a catalytic decomposition of hydrocarbon gas on metal nanoparticles and growth of carbon-based nanostructures. A processes for producing SWCNT according to the invention is described in U.S. Pat. No. 8,137,653, the disclosure of which is hereby incorporated herein for the method of making the SWCNT disclosed in the patent. In general, the process for making the SWCNT disclosed uses production in gas phase compared to a well-known and common process consisting of growing SWCNT on a catalytic surface.

The SWCNT may be size reduced by methods known in the art. For example, the SWCNT may be ground in known grinding equipment such as a ball mill or a basket mill, alternatively the SWCNT may be size reduced by treatment of a dispersion of the SWCNT in a matrix material with a blade or paddle mixer. One skilled in the art would know how to size reduce a SWCNT.

In one embodiment, the SWCNTs are supplied as an agglomeration of SWCNTs and the agglomerated SWCNTs are processed to reduce agglomeration prior to making the electrically conductive composition of the invention. The SWCNT agglomerations may be treated to reduce the agglomeration by methods known in the art as described for reducing the particle size of the SWCNT. One skilled in the art would know how to reduce the size of the agglomerations of SWCNTs.

The dielectric polymeric matrix material can be any polymeric matrix material known for use in medical or electronic applications. In one embodiment, the dielectric polymer matrix material comprises a polysiloxane, alternatively a silicone rubber, alternatively comprises a polysiloxane and is a hydrogel, an anhydrous gel, a thermoset, or thermoplastic, alternatively a thermoset or thermoplastic, alternatively a thermoset or thermoplastic elastomer. In one embodiment, the dielectric polymeric matrix material is a non-aqueous siloxane-based material. As used herein, “non-aqueous” means substantially free of water, alternatively free of water, alternatively has less than 0.1% (w/w) water.

The dieletric polymeric material is be capable of having the SWCNT dispersed in material to form a homogeneous dispersion of the SWCNT. In one embodiment, the dielectric polymeric matrix material has a rheology that ranges from visco-elastic to rubber. One skilled in the art would know how to select a dielectric polymer matrix material and what constitutes a visco-elastic and a rubber rheology. Many of materials that may be used as the dielectric polymer matrix material are available commercially.

Examples of the dielectric polymeric matrix material include, but are not limited to, styrenic resins, such as acrylonitrile butadiene styrene (ABS), acrylonitrile styrene acrylate (ASA), polystyrene (PS), Styrene acrylonitrile (SAN), Styrene-butane copolymers (SBC), styrene-ethylene-butylene-styrene copolymers (SEBS), styrene-butadiene rubber (SBR), styrene-butadiene block co-polymers (SBS), styrene-isoprene block copolymers (SIS), and styrene maleic anhydride (SMA); acetal resins such as polyoxymethylene (POM); polymers and copolymers derived from acrylic acid, acrylate, methacrylic acid or methacrylate compounds, such as alkyl acrylate copolymer (ACM), poly (acrylic acid) (PAA), polyacrylic acid sodium salt (PAAS), polyacrylamide (PAM), polyacrylonitrile (PAN), polyhydroxyethylmethacrylate (PHEMA), polymethylacrylate (PMA), and polymethylmethacrylate (PMMA); polyolefins, such as polyethylene (PE), polypropylene (PP), polymethylpentene (PMP), polybutene−1 (PB−1), polyolefin elastomers (POE), polyisobutylene (PIB), ethylene propylene rubber (EPR), and ethylene propylene diene monomer rubber (EPDM); polyvinylidene chloride (PVDC); polyvinylidene difluoride (PVDF); vinyl resins and copolymers, such as polyvinylalcohol (PVA), polyvinylacetate (PVAc), polyvinylchloride (PVC), and polyethylenevinylacetate (EVA); cyanoacrylates; aliphatic or semi-aromatic polyamides, such as polyamide Nylon-type (PA), polyphthalamide (PPA), polyamideimide (PAl), and aramid; aliphatic or aromatic polyimides such as polyimide (PI); polycarbonates, such as allyldiglycolcarbonate (ADC) and polycarbonate (PC); polyaryletherketones, such as polyaryletherketone (PAEK) and polyetherether ketone (PEEK); polyesters, such as poly-4-hydroxybutyrate (P4HB), polybutylene succinate (PBS), polybutylene terephthalate (PBT), polycaprolactone (PCL), polyethyleneadipate (PEA), polyethylene naphthalate (PEN), polyethylene terephthalate (PET), polyethylene terephthalate glycol-modified (PETG), polyglycolic acid (PGA), polyhydroxyalkanoates (PHAs), polyhydroxybutyrate (PHB), poly(3-hydroxybutyrate-co-3-hydroxyvalerate (PHBV), polyhydroxyhexenoate (PHH), polyhydroxyoctanoate (PHO), polyhydroxyvalerate (PHV), polylactic acid (PLA), poly(lactic-co-glycolic acid) (PLGA), and polytrimethylene terephthalate (PTT); alkyd resins; diallyl-phthalate (DAP); polyethers such as poly(p-phenylene ether) (PPE); phenolic resins such as (polyoxybenzylmethyleneglycolanhydride); formaldehyde resins, such as melamine formaldehyde and urea-formaldehyde (UF); epoxy resins; polybenzoxazines; furan resins; polysulfones, such as poly(arylene sulfone) (PAS), polyethersulfone (PES), poly(bisphenol-A sulfone) (PSF), polyphenylene sulfone (PPSU), and polysulfone (PSU); fluoropolymers, such as fluorinated ethylene propylene (FEP), perfluoroalkoxy alkane (PFA), polytetrafluoroethylene (PTFE); polyurethanes and polyureas sicu as thermoplastic polyurethane (TPU); polysaccharides, such as chitosan, chitin, pectin, starch, cellulose, hemicellulose based materials and derivatives; bioplastics and their blends and their copolymers; polysiloxane, such as liquid silicone rubber, silicone resin, silicone polymer, a mixture of silicone resin and silicone polymer and silicone hydrogel. Most of these materials are available commercially.

In one embodiment, the matrix material is a liquid silicone rubber. One skilled in the art would know how to select a liquid silicone rubber useful as the matrix material in the electrically conductive composition. The liquid silicone rubber may be formed from a one-part or two-part system, which is combined to form the liquid silicone rubber matrix material. The two-part system may comprise a first part comprising an organopolysiloxane containing two or more alkenyl groups bonded to silicon atoms per molecule and a second part comprising an organopolysiloxane comprising two or more hydrogen atoms bonded to silicon atom per molecule and a catalyst, typically a platinum-based catalyst, in the first part. One skilled in the art would know how to make or select a commercially available liquid silicone rubber suitable as the polymer matrix material. Methods of making the silicone rubber are known in the art. For example, patent application no. PCT/US2017/018687, which is hereby incorporated herein by reference for its description of making liquid silicone rubber, includes a description of such a method.

The polysiloxane may be a combination of polysiloxane materials such as a mixture of polysiloxane resin and polysiloxane polymer, where the polysiloxane resin comprises “Q” units (i.e., SiO_{4/2}) and may contain one or more of T (i.e., RSiO_{3/2}), D (i.e., R₂—SiO_{2/2}), and M (i.e., R₃SiO_{1/2}) units, where each R is independently a C1-C4 hydrocarybyl or hydrogen, and the polysiloxane polymer typically contains primarily D and M units but may contain some T units, where D, M, and T units are as described above. As used herein with respect to the polysiloxane, mixture includes physical mixtures and where the polysiloxane resin is chemically bonded to the polysiloxane polymer.

The dielectric matrix material may be a polysiloxane hydrogel. Polysiloxane hydrogels are available commercially. One skilled in the art would know how to select a polysiloxane hydrogel to use as the dielectric matrix material. Methods of making polysiloxane hydrogels are known in the art.

The dielectric polymer matrix material may comprise additional materials typically found in liquid silicone rubbers such as adhesion promoters, inhibitors, and fillers. One skilled in the art would know how to select adhesion promoters, inhibitors, and fillers, which are available commercially.

The conductive filler can be made of intrinsically conductive polymers, ionic polymers and their salts thereof. The conductivity of the polymer is achieved through conjugated double bonds, which allow free mobility of charge carriers in the doped state or through ionic functionality. The conductive polymers include for example polyacetylene or polyethyne, polypyrrole (PPY), polythiophene, polyaniline (PANi) including the emeraldine form, poly(3,4-ethylenedioxythiophene) (PEDOT), poly(3,4-ethylenedioxythiophene): polystyrenesulfonate (PEDOT:PSS), perfluorosulfonic acid or perfluorocarboxylic acid polymers, and ormolytes such as siloxane-polypropyleneoxide. The conductive fillers can be doped to enhance their conductivity according to their chemical structures with p-type dopants including Br₂, I₂, Cl₂, and AsF₅, with n-type dopants including lithium, sodium and potassium, with acidic dopants like HBr, d,l-camphorsulfonic acid (CSA) or dodecyl benzene sulfonic acid (DBSA), with counter anions like tosylate (Tso) or trifluoromethanesulfonate (OTf), and with specific treatment with solvents, such as cresol, dimethyl sulfoxide, dimethylformamide, ethylene glycol, glycerol, sorbitol, salts, zwitterions, acids, alcohols, glycols and fluoro-compounds. Methods of making the conductive fillers, dopants, and solvents are known in the art and available commercially.

The electrically conductive composition may comprise additional materials commonly included in electrically conductive materials. In one embodiment, the electrically conductive composition further comprises a filler. In one embodiment, the electrically conductive composition comprises a filler and the filler comprises metallized particles obtained by coating a non-metallic particles with metal material. The particles can be tube, fiber, spheres, beads, spheroid powders or any kind of particles in the size domain ranging from nanometer to micrometer. Their surfaces are metallized to enhance their electrical conductivity. The metallic coating can be any kind of metal such as silver, copper, platinum, iron, aluminum and their alloys. The particle material can be glass, silica, carbon black powder, graphene, carbon nanotube, carbon fiber, plastic or rubber particles. Methods of making metallized particles are known in the art. Many metallized particles are available commercially.

Another aspect of the invention is a method of making a conductive composition, comprising the step of: combining 0.1%-5% (w/w) single wall carbon nanotubes with a dielectric matrix material to form a homogeneous dispersion of the single wall carbon nanotubes in the dielectric matrix material and to reduce the size of the agglomerates of the single wall carbon nanotubes.

The single wall carbon nanotubes and the dielectric matrix material are as described above.

The single wall carbon nanotubes and dielectric matrix material are combined to form a homogeneous dispersion. The combination may be done according to methods known in the art that will form a homogeneous dispersion. For example, the single walled carbon nanotubes and the dielectric matrix material may be combined using a dental mixer, ultrasonification, mixing in a homogenizer, or mixing with a paddle mixer, alternatively the dispersion is formed by (ii) mixing the single wall carbon nanotubes with the dielectric matrix material with a high sheer mixer, (ii) dilution of the dielectric matrix material with a volatile fluid, (iii) combining a processing aid with the single wall carbon nanotube and the dielectric matrix material, or (iv) a combination of two or more of (i), (ii), or (iii). One skilled in the art would know how to combine the dielectric matrix material and the single walled carbon nanotubes.

The method of making a conductive composition may further comprise one or more of the additional steps of heating, casting, molding, and shaping.

The method may further comprise forming the electrically conductive composition into an electrode. One skilled in the art would know how to form the electrically conductive composition into an electrode.

The method of making the electrically conductive composition may be made at standard temperature and pressure, alternatively from standard temperature and pressure to elevated temperature and pressure. One skilled in the art would know the temperature and pressure to use to make the electrically conductive composition. In one embodiment, the electrically conductive composition is made at by creating the dispersion at from 15° C. to 30° C., alternatively 18° C. to 25° C. and at a pressure from 100 kPa to 200 kPa, alternatively 100 kPa to 120 kPa.

In one embodiment, the method of making the electrically conductive composition further comprising heating the combination of the dielectric matrix and the SWCNT to elevated temperature, alternatively a temperature above room temperature, alternatively from 30° C. to 150° C., alternatively from 50° C. to 130° C. to cure the dielectric matrix. One skilled in the art would know how to heat the electrically conductive composition to cure the dielectric matrix and would know when the dielectric matrix requires curing.

The electrically conductive composition may be made in a standard vessel such as a stainless-steel reactor or mixing pot. One skilled in the art would know how to select a container in which to make the electrically conductive composition.

The electrically conducive composition is made by mixing the SWCNT and dielectric matrix material for a time sufficient, alternatively up to an hour, alternatively from 1 min. to 2 hours, to form a dispersion of the SWCNT in the dielectric matrix material.

The electrically conductive composition of the invention is adhesive to skin and may be used as an adhesive in medical applications requiring the measurement of biological electrical signals such as veterinary, consumer, pharmaceutical, or medical electronic devices.

A device, comprising: a conductive trace, an electrode or electrical connection, wherein the conductive trace, electrode or electrical connection comprises the electrically conductive composition as described above. One skilled in the art would know how to make an electrode or electrical connection comprising the electrically conductive composition described above.

An adhesive patch or tape comprising the electrically conductive composition described above. One skilled in the art would know how to make an adhesive patch or tape comprising the electrically conductive composition described above.

The electrically conductive composition of the invention may be used to make wearable electronics such as electrodes. The method of making the electrically conductive filler produces an electrically conductive material with improved impedance and adhesive properties.

### EXAMPLES

The following examples are presented to better illustrate the method of the present invention but are not to be considered as limiting the invention, which is delineated in the appended claims. Unless otherwise noted, all parts and percentages reported in the examples are by weight. The following table describes the abbreviations used in the examples:

TABLE 1
List of abbreviations and terms used in the examples.

| Abbreviation | Word |
|---|---|
| wt | Weight |
| % | percent |
| mol | mole |
| hr | hour |
| ° C. | degree Celsius |
| mL | milliliters |
| cm | Centimeter |
| SWCNT | Single wall carbon nanotube |
| MWCNT | Multiple wall carbon nanotube |
| TEM | Transmission Electron Microscope |
| ECG | Electrocardiogram |
| Mm | Millimeters |
| S | Seconds |
| V | Volts |
| mV | Millivolts |
| Kg | kilogram |

### List of Materials Used in the Examples

Liveo™ QP1-250 Liquid Silicone Rubber (Liquid Silicone Rubber is a two-part platinum-catalyzed elastomer. After a thermal cure, the resulting elastomer consists of a cross-linked dimethyl and methyl-vinyl siloxane copolymers reinforced with silica).

Live™ MG 7-1010 Soft Skin Adhesive (Soft Skin Adhesive is a two-part platinum-catalyzed low-viscosity silicone adhesive gel).

Carbon Black=Cabot, VXC72 lot4585896, cas:1333-86-4

MWCNT NC7000™ from Nanocyl (Multi Wall Carbon Nanotubes consist of a powder of Multi Wall Carbon Nanotubes).

SWCNT from OCSiAl (Single Wall Carbon Nanotubes consist of a powder of single wall carbon nanotubes (95% of SWCNT)).

SWCNT Matrix 601 from OCSiAl (Matrix 601 consist of a 10wt % dispersion of single wall carbon nanotubes into a polydimethylsiloxane fluid).

Dow corning TI-1050 fluid 100 cSt—polydimethylpolysiloxane of a viscosity of 100 cSt).

Intexar products (stretchable silver conductor paste for printed low-voltage circuitry on elastic film and textile substrates. PE873 is a silver-bearing conductor):
PET PE874 on PET film
PET PE876 on PET film
TPU PE874 on PET film
TPU PE876 on PET film

### PTFE—Teflon, Durafilm, 135′500A×12

Mylar (reinforce), roll width 12 inch (ID:MMQSD0104309001)

### Test Methods

Adhesion Peel: The equipment used to measure the peel adhesion of the silicone adhesive strip samples was a Stable Micro Systems Texture Analyzer, Model TA-XT Plus. Settings for the peel tests were as follows: 180° C.; Test Speed—10 mm/s; Distance between clamps—115 mm; Load Cell—5 kg. The adhesive was coated on a polyester substrate and the sample adhesion force was measured on a polycarbonate substrate instead of skin.

### Conductivity

Current measurement leading to volume resistivity calculation: The conductive material (known length, width and thickness) was connected to a source meter (Keithley 2450 Source meter) with crocodile clamps. A voltage was applied (between 5 mV and 10 V) and current (limit of detection at 1.05 A) was measured (at 5 points or with a linear dual sweep of 200 points). Volume resistivity was calculated via formula:

$$R = \frac{U}{I}$$

$$ρ = \frac{R * S}{L}$$

Where:
R=Resistance (Ohm or Ω)−U=Voltage (V)−I=Current (A)−ρ=Resistivity (Ohm m Ω·m)−S=Surface (m²)−L=length (m)

### ANSI/AAMI EC 12:2000 Standard Test

The objective of this standard was to provide minimum labeling, safety, and performance requirements that will help ensure safety and efficacy in the clinical use of disposable electrocardiographic (ECG) electrodes.

Electrodes were connected back-to-back, so there was no need for human subjects. Parameters and performance requirements for the testing are listed in the following table.

| | | | | Value | |
|---|---|---|---|---|---|
| Section | Requirement description | Test conditions | Units | (Min/Max) | |
| 4.2.1 | All requirements of this standard | Up to the “use before” date according to | | | |
| | shall be met | 4.1 a), under the storage conditions | | | |
| | | according to 4.1 d) | | | |
| 4.2.2.1 | Average value of 10-Hz | Pairs connected gel-to-gel, impressed | kΩ | 2 | (max) |
| | impedance for 12 electrode pairs | current not exceeding 100 μA | | | |
| | Individual pair impedance | | kΩ | 3 | (max) |
| 4.2.2.2 | Offset voltage | Pair connected gel-to-gel, after 1-min | mV | 100 | (max) |
| | | stabilization | | | |
| 4.2.2.3 | Combined offset instability and | Pair connected gel-to-gel, after one-minute | μV | 150 | (max) |
| | internal noise | stabilization period, in the passband of 0.15 | | | |
| | | to 100 Hz, for 5 min | | | |
| 4.2.2.4 | Defibrillation overload recovery | Pair connected gel-to-gel, 5 seconds after | mV | 100 | (max) |
| | (polarization potential) | each of four discharges of 200 volts | | | |
| | Rate of change of polarization | During 30-sec interval following polarization | mV/sec | 1 | (max) |
| | potential | potential measurement | | | |
| | After test, 10-Hz electrode | | kΩ | 3 | (max) |
| | impedance | | | | |
| 4.2.2.5 | DC voltage offset | Pair connected gel-to-gel, continuous | mV | 100 | (max) |

200 nA DC current applied over clinical use
period (in no case less than 8 hours)

### Results (Pass/Fail) of the Standard Tests Follows

| | ANSI/AAMI |
|---|---|
| | EC12:2000 |
| Dry electrode | Standard test |
| SSA MG7-1010 - 1.5% (w/w) SWCNT | Pass |
| SSA MG7-1010 - 1.5% SWCNT - 6 Month Old | Pass |
| LSR QP1-250 - 1.5% SWCNT | Pass |

### Morphology

### TEM

### Sample Preparation

Samples were provided as thick films (<500 μm thick). Sub-sections were cut from the film using a razor blade. Subsections measured 8 mm×0.75 mm×original sample thickness. Sub-sections were embedded in epoxy (using 100:23 resin: hardener ratio by weight). 100 nm thick sections (from 0.75 mm×original sample thickness plan) were collected using the settings in the microtome below. Sections were collected onto a carbon coated TEM grid at cryo temps and a Gatan cyro-transfer holder was used to transfer and image grids in the TEM at less than −40° C. Images were collected with a Gatan OneView camera in the TEM using the conditions outlined in the following table:

| Microtome | Condition | | TEM | Condition |
|---|---|---|---|---|
| Model | Leica UC7 | | Model | JEOL FS2200 |
| Knife | MicroStar 45° Dry | | Source | Cold-FEG |
| Temp | −140° | C. | Accelerating | 200 kV |
| | | | Voltage | |
| Feed | 100 | nm | Magnifications | 2, 8, 10, 40 Kx |
| Speed | 1.2 | mm/s | Method | Sections on grid |

| | |
|---|---|
| Imaging | Cryo (below −40° |
| Temperature | C.) |

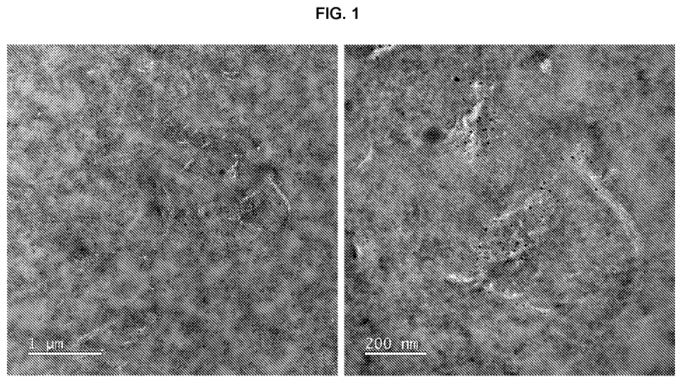

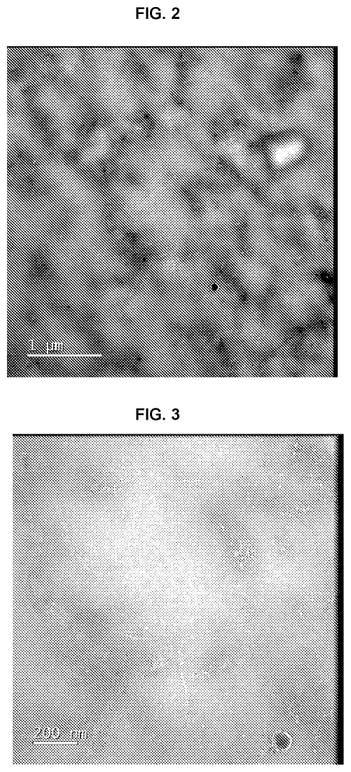

The images of the morphology of the films taken by TEM is in FIG. 1-3

### Simulator: Fluke Impulse 6000D Defibrillator Analyzer

This test allows the simulation of an ECG signal without human skin contact with two electrode/electrode prototype.

Two electrodes were place on the simulator and analyzed with the following parameters:
Signal: Normal Sine @60 bpm
Connections: Lead-I (RA:-ve; LA:+ve, LL:G)
Measurement time: ˜2 min
Segment length for analysis: 8 s
Give a reference signal and a simulated signal

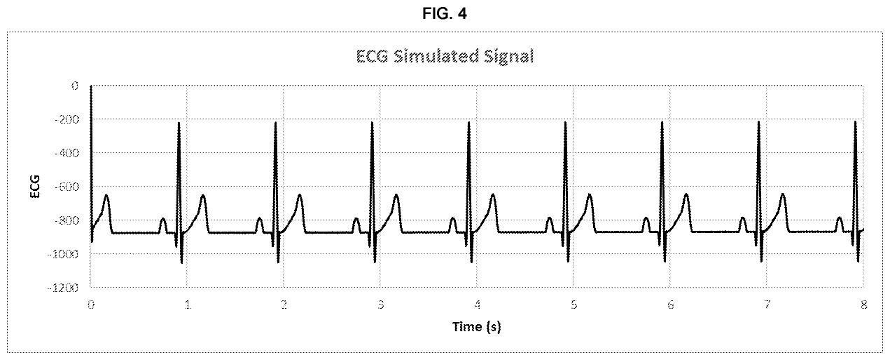

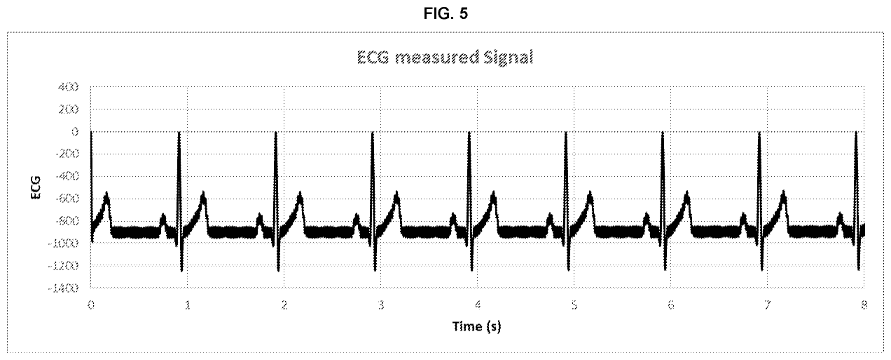

The results of the analysis are in FIGS. 4 and 5

### Rheology

### SSA

Strain sweeps were performed on a TA ARES-G2 rheometer with 25 mm stainless steel parallel plates. The sample was placed between the plates to achieve a gap of ˜0.5 mm and the excess was trimmed. The strain sweeps were conducted at 32° C. from 0.1% to 100% strain at 2 rad/s. Data collection was set for 5 pts/decade.

Frequency sweeps were performed on a TA ARES-G2 rheometer with 25 mm stainless steel parallel plates. The sample was placed between the plates to achieve a gap of −0.5 mm and the excess was trimmed. The Frequency sweeps were conducted at 32° C. from 1 rad/s to 100 rad/s with a 10% strain (in the linear viscoelastic region). Data collection is set for 5 pts/decade.

The viscosity was measured on the TA ARES-G2 rheometer with 25 mm stainless steel parallel plates. Using a gap of 0.5 mm and a flow analysis at 2.61 rad/s for 10 min.
The curing characteristics were determined using the Alpha Technologies MDR2000 using the following conditions: 5+/−0.05 g of material, 50 LB-Inches torque range, 130° C. and 6 min test time.

### LSR

Strain sweeps were performed on a TA ARES-G2 rheometer with 25 mm stainless steel parallel plates. The sample was placed between the plates to achieve a gap of −0.5 mm and the excess was trimmed. The strain sweeps were conducted at 25° C. from 0.1% to 100% strain at 10 rad/s. Data collection was set for 5 pts/decade.

Frequency sweeps were performed on a TA ARES-G2 rheometer with 25 mm stainless steel parallel plates. The sample was placed between the plates to achieve a gap of ˜0.5 mm and the excess was trimmed. The Frequency sweeps were conducted at 25° C. from 0.1 rad/s to 100 rad/s with a 0.5% strain (in the linear viscoelastic region). Data collection was set for 5 pts/decade.

The curing characteristics were determined using the Alpha Technologies MDR2000 using the following conditions: 5+/−0.05g of material, 50 LB-Inches torque range, 150° C. and 6 min test time.

### Mixing Process & Application Process

MWCNT and fluid premix were weighed and mixed at 1000 rpm for 3 minutes and then at 2000 rpm for 30 seconds using a dental mixer. The CNT or the premixed MWCNT nd part B were weighed and mixed at 2400 rpm for 30 seconds and then at power max for seconds using a dental mixer. It was then mixed for 10 minutes with a propeller mixer. Part A was then added and mixed for 30 seconds at 2400 rpm, then manually mixed with a wooden spatula and then mixed again 30 seconds at power max using the dental mixer. The product was poured between two PTFE sheets or one Intexar substrate and one PTFE sheet or two Intexar substrates using either a mold to get 2 mm thickness sheet or shims from 0.0025 inches to 0.04 inches. And then it was put between two metallic plates. For LSR, metallics plates were put in the Lescuyer press for 10 minutes at a pressure of 100 bars at 120° C. For SSA, metallics plates were put in the Lescuyer press for 5 minutes at a pressure of 100 bars at room temperature and the metallic plates were then removed and materials was put in an oven for 10 minutes at 120° C.

### Formulations

| Comparative Example | LSR QP1-250 with 1.5% MWCNT |
|---|---|
| 1 (Formulation 1) | |
| Comparative Example | LSR QP1-250 MWCNT premixed loading |
| 2 (Formulation 2) | 1.5% (w/w) |
| Example 1 | LSR QP1-250 with 1.5% SWCNT matrix |
| (Formulation 3) | 601 |
| Example 2 | LSR QP1-250 with0.5% SWCNT matrix 601 |
| (Formulation 4) | |
| Examples 3 | LSR QP1-250 with 1% SWCNT matrix 601 |
| (Formulation 5) | |
| Examples 4 | SSA MG7-1010 with 1.5% SWCNT matrix |
| (Formulation 6) | 601 |

### Comparison Testing

### Evolution with Various CNT

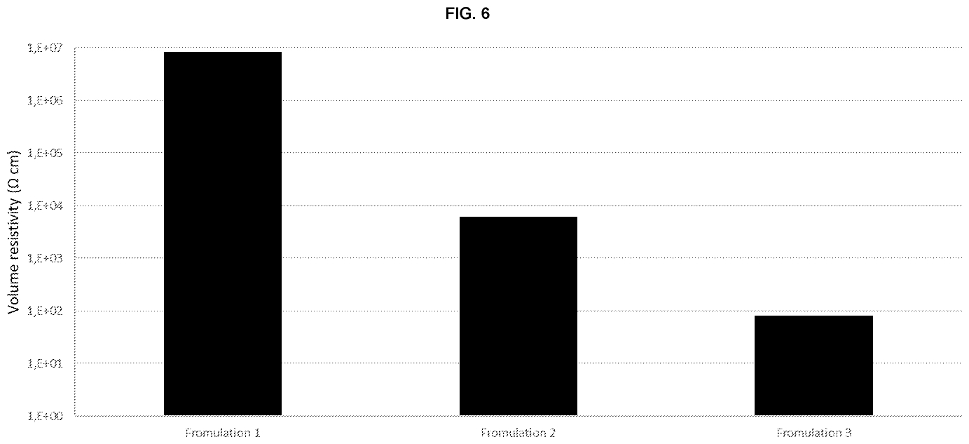

Samples made of free standing LSR material cut 8 cm×2 cm. Current measurements were made at 10 V. (Volume Resistivity at 10 V of LSR QP1-250 loaded with 1.5% of various CNT.) The graph of the measurements is in FIG. 6

| | |
|---|---|
| Comparative | LSR QP1-250 MWCNT Pure loading 1.5% (w/w) |
| Example 1 | |
| (Formulation 1) | |
| Comparative | LSR QP1-250 MWCNT premixed loading 1.5% |
| Example 2 | (w/w) |
| (Formulation 2) | |
| Examples 1 | LSR QP1-250 SWCNT Matrix 601 loading 1.5% |
| (Formulation 3) | (w/w) |

### Evolution with Different Loading Level of SWCNT Matrix 601

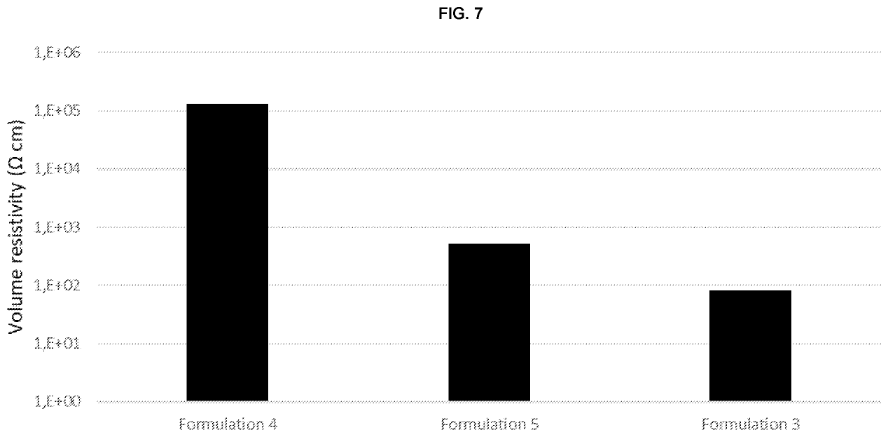

Samples made of free standing loaded LSR material cut 8×2 cm. Current measurement were made at 10 V. (Volume Resistivity at 10 V of LSR QP1-250 loaded with 0.5%-1% or 1.5% (w/w) SWCNT.) The graph of the measurements is in FIG. 7.

| | |
|---|---|
| Example 2 | LSR QP1-250 SWCNT Matrix 601 Loading0.5% |
| (Formulation 4) | (w/w) |
| Examples 3 | LSR QP1-250 SWCNT Matrix 601 Loading 1% |
| (Formulation 5) | (w/w) |
| Example 1 | LSR QP1-250 SWCNT Matrix 601 Loading 1.5% |
| (Formulation 3) | (w/w) |

### Thickness Influence

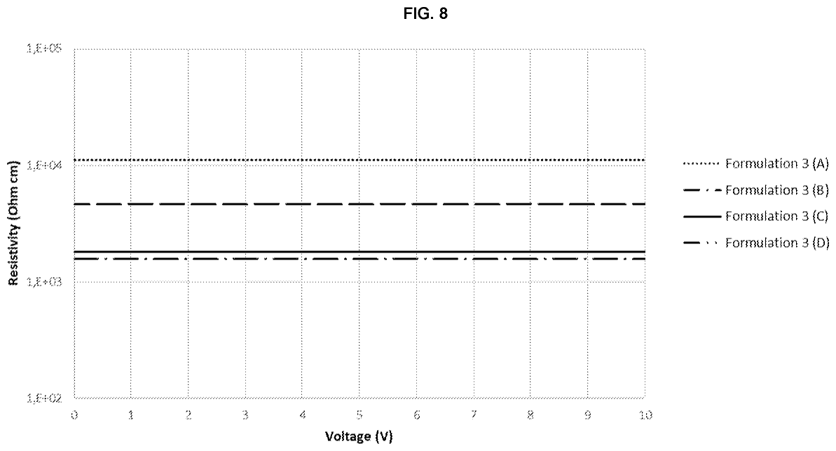

Samples made of loaded LSR coated on Intexar prototype electrode made of PET PE876. (Resistivity vs Voltage—Up & Down Electrode made of LSR QP1-250 1.5% (w/w) SWCNT matrix 601 on PET PE876). The graph of the measurements is in FIG. 8

| | | |
|---|---|---|
| Examples 5 | LSR QP1-250 1.5% (w/w) SWCNT matrix | 319 μm |
| (Formulation 3 | 601 - PET PE 876 | |
| (A)) | | |
| Example 6 | LSR QP1-250 1.5% (w/w) SWCNT matrix | 347 μm |
| (Formulation 3 | 601 - PET PE 876 | |
| (B)) | | |
| Examples 7 | LSR QP1-250 1.5% (w/w) SWCNT matrix | 450 μm |
| (Formulation 3 | 601 - PET PE 876 | |
| (C)) | | |
| Example 8 | LSR QP1-250 1.5% (w/w) SWCNT matrix | 575 μm |
| (Formulation 3 | 601 - PET PE 876 | |
| (D)) | | |

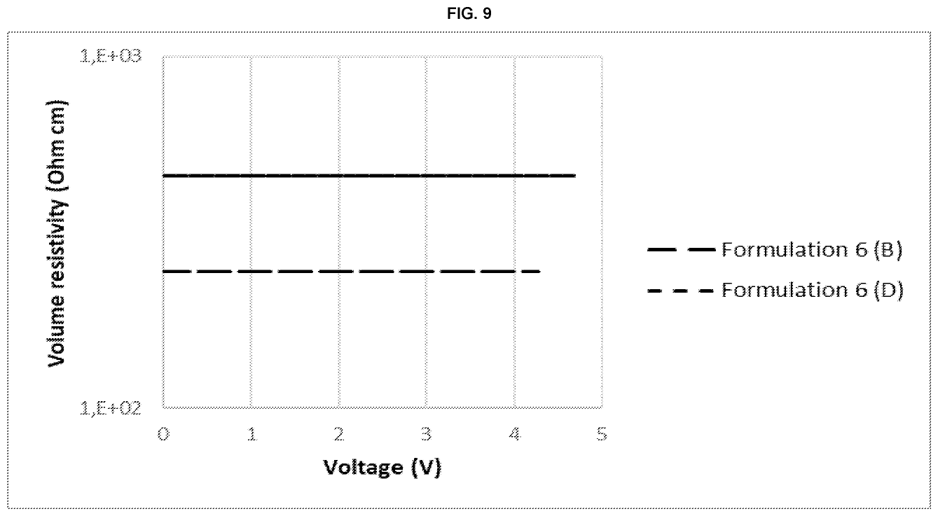

Sample made with SSA MG7-1010 loaded with 1.5% SWCNT matrix 601 coated on PET PE874. The graph of the measurement is in FIG. 9.

| | |
|---|---|
| Example 9 | SSA MG7-1010 1.5% (w/w) SWCNT matrix 601 Press |
| (Formulation 6 | and cured by heat between two Intexar substrates PE |
| (B)) | PET874 − 0.04 inch shims used = 530 μm |
| Examples 10 | SSA MG7-1010 1.5% (w/w) SWCNT matrix 601 Press |
| (Formulation 6 | and cured by heat between two Intexar substrates PE |
| (D)) | PET874 − 0.03 inch shims used = 326 μm |

### Interface Impact

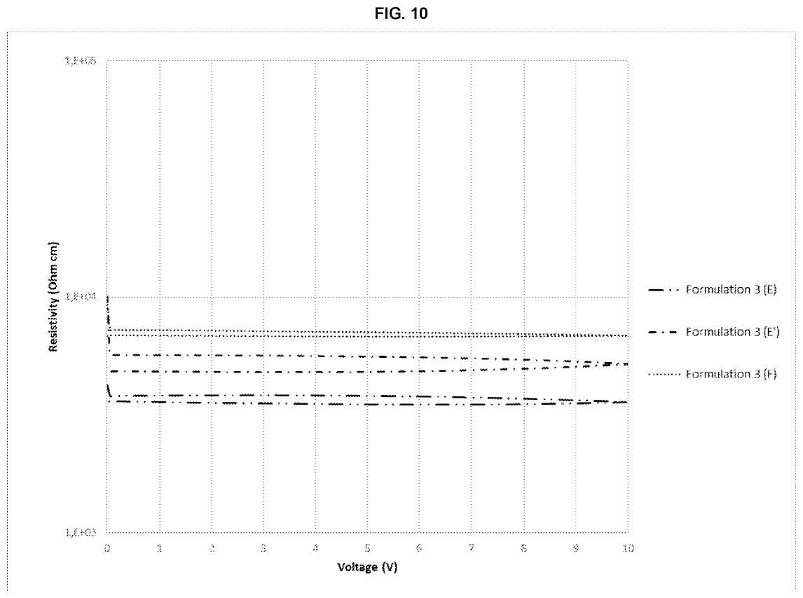

LSR loaded with 1.5% SWCNT coated between 2 Intexar electrodes PET PE674 (Resistivity VS Voltage for LSR loaded with 1.5% CNT2 coated between 2 intexar electrodes PET PE674.) The graph of the results is in FIG. 10

| | | |
|---|---|---|
| Examples | LSR QP1-250 loaded 1.5% SWCNT matrix 601 | 329 μm |
| 11 | coated between two Intexar substrates PET | |
| (Formulation | PE876 (unstick-stick) | |
| 3 (E)) | | |
| Example 12 | LSR QP1-250 loaded 1.5% SWCNT matrix 601 | 329 μm |
| (Formulation | coated between two Intexar substrates PET | |
| 3 (E′)) | PE877 | |
| Example 13 | LSR QP1-250 loaded 1.5% SWCNT matrix 601 | 645 μm |
| (Formulation | coated between two Intexar substrates PET | |
| 3 (F)) | PE878 (2 put together) | |

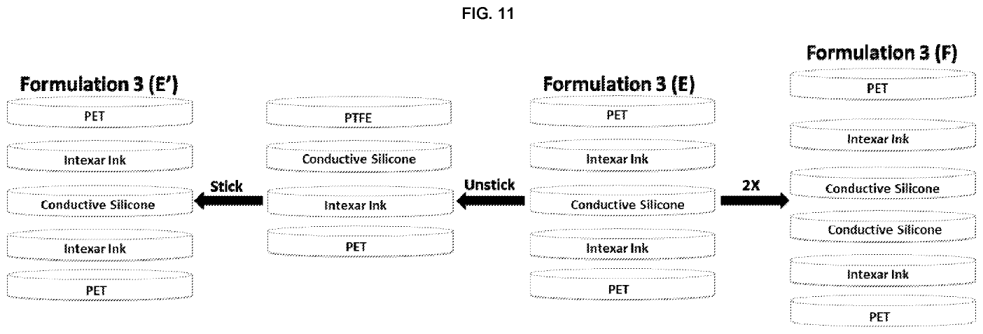

The configuration of the samples is shown in FIG. 11

### Transfer Impact

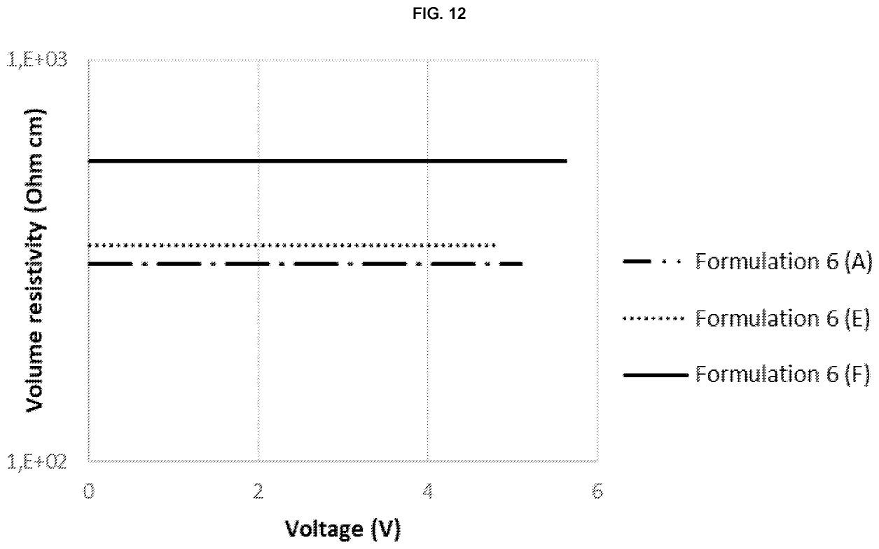

Calculated volume resistivity as a function of voltage for transfer coated electrodes made of SSA MG7-1010 loaded with 1.5% (w/w) SWCNT matrix 601. The graph of the results is in FIG. 12

| | |
|---|---|
| Example 14 | SSA MG7-1010 1.5% (w/w) SWCNT matrix 601 Cold |
| (Formulation | press cured by heat between two Intexar substrates PE |
| 6 (A)) | PET874 − 0.03 inch shims used = 487 μm |
| Example 15 | SSA MG7-1010 1.5% (w/w) SWCNT matrix 601 Cold |
| (Formulation | press between PTFE − transfer coated with AP on PE PET |
| 6 (E)) | 874 = 435 μm |
| Example 16 | SSA MG7-1010 1.5% (w/w) SWCNT matrix 601 Cold |
| (Formulation | press between PTFE − transfer coated without AP on PE |
| 6 (F)) | PET 874 = 515 μm |

1. an electrically conductive composition, comprising:
a homogeneous dispersion of
(a) up to 5% (w/w) single wall carbon nanotubes, in
(b) a dielectric polymeric matrix material.

2. The electrically conductive composition according to claim 1, wherein (I) the dielectric polymeric matrix material is a non-aqueous siloxane-based material, (II) the single wall carbon nanotubes are size-reduced, (III) the single wall carbon nanotubes have a maximum particle size, (IV) the single wall carbon nanotubes have been processed to reduce agglomeration, or (V) a combination of two or more of (I), (II), (III), and (IV).

3. The electrically conductive composition according to claim 2, wherein the non-aqueous siloxane-based material (I) is a thermoset or thermoplastic.

4. The electrically conductive composition according to claim 3, wherein the thermoset or thermoplastic is an elastomer and the rheology of the elastomer is from rubber to visco-elastic.

5. The electrically conductive composition according to claim 4, where in the elastomer is a polysiloxane elastomer.

6. The electrically conductive composition according claim 1 further comprising a filler.

7. The electrically conductive composition according to claim 6, wherein the filler is silica, siloxane resin, a conductive filler, or a combination thereof.

8. The electrically conductive composition according to claim 7, wherein the filler is a conductive filler selected from the group consisting of fullerene, graphite, graphite fiber, graphene, exfoliated graphite nano-platelet, metal, or metallized particle.

9. The electrically conductive composition according to claim 1, wherein the electrically conductive composition is adhesive to skin, a keratinous substrate, or mucosa.

10. The electrically conductive composition according to claim 1 where the composition transmits an electrical or thermic signal from or to the body.

11. The electrically conductive composition according to claim 1, where the composition increases the diffusion of substances.

12. The electrically conductive composition according to claim 1, where the composition forms an electrode or electrical connection in a veterinary, consumer, pharmaceutical, or medical electronic device.

13. The electrically conductive composition according to claim 1, wherein the composition is part of an adhesive patch or tape.

14. A device, comprising: a conductive trace, an electrode or electrical connection, wherein the conductive trace, electrode or electrical connection comprises the composition according to claim 1.

15. A method of making a conductive composition, comprising the step of:
combining 0.1-5% single wall carbon nanotubes with a dielectric matrix material to form a homogeneous dispersion of the single wall carbon nanotubes in the dielectric matrix material and to reduce the size of the agglomerates of the single wall carbon nanotubes.

16. The method of claim 15, wherein the dielectric matrix material is a silicone material.

17. The method of claim 15, wherein the dispersion is formed by (ii) mixing the single wall carbon nanotubes with a high sheer mixer, (ii) dilution of the dielectric polymeric binder with a volatile fluid, (iii) combining a processing aid with the single wall carbon nanotube and the dielectric matrix material, or (iv) a combination of two or more of (i), (ii), or (iii).

18. The method of claim 15, further comprising forming the conductive composition into an electrode.
